(19) United States
(12) Patent Application Publication
(10) Pub. No.: US 2006/0137812 A1
(43) Pub. Date: Jun. 29, 2006

(54) Vessel and method for forming same

(76) Inventors: Elizabeth Davis, Park City, UT (US); Mark Hale, Draper, UT (US)

Correspondence Address: THORPE NORTH & WESTERN, LLP., 8180 SOUTH 700 EAST, SUITE 200, SANDY, UT, 84070, US

(21) Appl. No.: 11/286,273

(22) Filed: Nov. 22, 2005

Related U.S. Application Data
(62) Division of application No. 10/735,404, filed on Dec. 12, 2003.

(51) Int. Cl. B29D 31/00

(52) U.S. Cl. 156/242

(57) ABSTRACT

A vessel includes an inner layer forming a substantial enclosure and including a chemically inert material. An intermediate or bondable layer is mechanically attached to the inner layer. The intermediate layer can include a fibrous material. An outer layer is bonded to the intermediate layer, and surrounds at least a portion of the inner layer. A method for forming the vessel includes disposing a bondable layer against an inner surface of a mold shaped to form a substantial enclosure. A preform formed of a plastic material is disposed into the mold. The preform is heated and pressurized causing the preform to expand to conform to the mold to form the substantial enclosure, and causing the plastic material to embed into an exposed portion of the bondable layer. The substantial enclosure with the bondable layer is removed from the mold. Another item is bonded to the bondable layer.

### PRIORITY CLAIM

This is a divisional of U.S. patent application Ser. No. 10/735,404, filed Dec. 12, 2003, which is herein incorporated by reference.

### BACKGROUND OF THE INVENTION

1. Field of the Invention

The present invention relates generally to a vessel, such as a reinforced plastic vessel, and a method of forming the vessel.

2. Related Art

Rotomolded storage tanks are used in various industries, such as chemical, industrial, aerospace, marine, and oil and gas industries. Plastic materials are often used to manufacture such tanks, particularly in aeronautical and deep-sea applications. The plastic material allows for the production of tanks that are watertight, lightweight, and of relatively low cost. It is often necessary, however, to reinforce these tanks so that they are strong enough to withstand structural loads due to the weight of the contents, operating pressures and temperatures, environmental conditions, etc.

Applying reinforcement material to these tanks can be problematic because most thermoplastics, and especially polyolefins, have very low surface energies that make it difficult or impossible to create a structural bond between the vessel wall and the reinforcing material.

### SUMMARY OF THE INVENTION

It has been recognized that it would be advantageous to develop a vessel, or a reinforced vessel, that is lightweight, yet able to withstand structural loads due to the weight of the contents, operating pressures and temperatures, and/or environmental conditions, etc. In addition, it has been recognized that it would be advantageous to develop a reinforced plastic vessel. Furthermore, it has been recognized that it would be advantageous to develop a chemically inert vessel reinforced with a fiber and resin composite material.

The invention provides a vessel device with an intermediate or bondable layer mechanically attached to an inner layer forming a substantial enclosure. The intermediate or bondable layer can include a fibrous material, while the inner layer can include a chemically inert material. An outer layer is bonded to the intermediate layer, and surrounds at least a portion of the inner layer. The outer layer can be a reinforcement layer, and can include fiber in a resin matrix.

In accordance with a more detailed aspect of the present invention, the fibrous material of the intermediate layer can be at least partially imbedded in the inner layer. The intermediate layer can be at least partially bonded to the outer layer.

In addition, the invention provides a method for forming the vessel that includes disposing a bondable layer against an inner surface of a mold shaped to form a substantial enclosure. A preform formed of a plastic material is disposed into the mold. The preform is heated and pressurized causing the preform to expand to conform to the mold to form the substantial enclosure, and causing the plastic material to embed into an exposed portion of the bondable layer. The substantial enclosure with the bondable layer is removed from the mold. Another item is bonded to the bondable layer.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1a is a perspective view of a vessel in accordance with an embodiment of the present invention;

FIG. 1b is a detailed cross-sectional view of the vessel of FIG. 1a;

FIG. 1c is a perspective view of another vessel in accordance with an embodiment of the present invention;

FIGS. 2a-5c are various schematic views of a method for forming a vessel in accordance with an embodiment of the present invention;

FIG. 2a is a perspective view of a mold shown in an open configuration;

FIG. 2b is a partial, cross-sectional side view of the mold of FIG. 2a;

FIG. 3a is a perspective view of the mold with a bondable layer on an inner surface thereof and a plastic material being introduced therein;

FIG. 3b is a partial, cross-sectional side view of the mold with a bondable layer therein of FIG. 3a;

FIG. 3c is a perspective view of the mold with a bondable layer on an inner surface thereof and a preform formed of a plastic material being introduced therein;

FIG. 4a is a perspective view of the mold shown in a closed configuration and being subjected to heat and internal pressure;

FIG. 4b is a partial, cross-sectional side view of the mold with the bondable layer and a plastic material or inner layer conformed to the mold and embedded into the bondable layer;

FIG. 5a is a perspective view of a substantial enclosure with the bondable layer with a reinforcement layer being formed thereon;

FIG. 5b is a partial, cross-sectional side view of the substantial enclosure with the bondable layer of FIG. 5a;

FIG. 5c is an enlarged, partial, cross-sectional side view of the substantial enclosure with the bondable layer of FIG. 5b;

FIG. 6a is a perspective view of a vacuum mold;

FIG. 6b is a perspective view of the mold of FIG. 6a with a bondable layer on an inner surface thereof;

FIG. 6c is a perspective view of the mold of FIG. 6b with a plastic material being introduced therein; and

FIG. 6d is a perspective view of the mold of FIG. 6c being subjected to heat and internal pressure.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

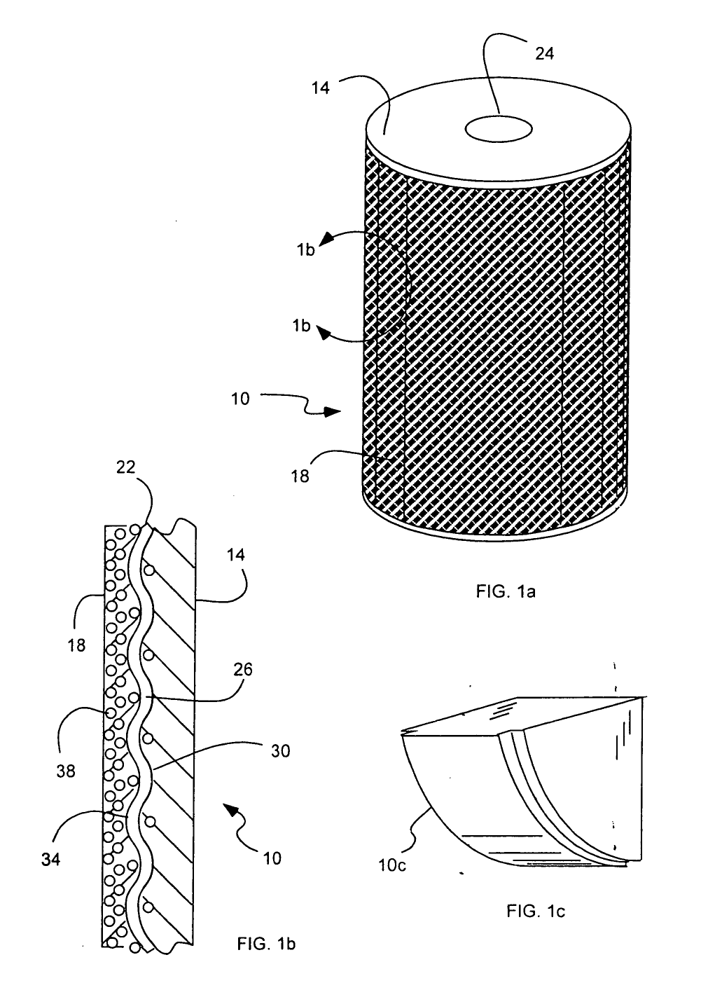

As illustrated in FIGS. 1a and 1b, a vessel, indicated at 10, in accordance with the present invention is shown. The vessel 10 can form or include a substantial enclosure 14, such as a tank, container, etc. Such vessels can be utilized in chemical, industrial, aerospace, marine, and oil and gas industries, and can be used to hold or contain various different materials and liquids, including for example, water, oil, gasoline, or other chemicals. The vessel 10 can include a chemically inert material, such as a thermoplastic, or polyolefin. Thus, the vessel can be watertight, lightweight, and of relatively low cost. In addition, the vessel 10 can be reinforced, or can be a reinforced vessel, so that the vessel can be strong enough to withstand structural loads due to the weight of the contents, operating pressures and temperatures, environmental conditions, etc. The vessel 10 can be reinforced by a reinforcement layer 18, such as a fiber and resin composite material.

As described above, applying a reinforcement material to a vessel can be problematic because a chemically inert material of the vessel can have a very low surface energy that makes it difficult or impossible to create a structural bond between the vessel and the reinforcing material. Thus, the reinforcement can fail to sufficiently attach, or can later delaminate. Therefore, the vessel 10 or substantial enclosure 14 advantageously includes a bondable layer or intermediate layer 22 disposed between the substantial enclosure 14 and the reinforcement layer 18. The bondable or intermediate layer 22 can be mechanically coupled to the substantial enclosure 14 and bonded to the reinforcement layer 18. Therefore, the bondable or intermediate layer 22 couples the reinforcement layer 18 to the substantial enclosure 14.

Although the vessel 10 and the substantial enclosure 14 are shown in the Figures as having a cylindrical shape, it will be appreciated that the vessel and substantial enclosure can have any desired shape, or a non-cylindrical shape. For example, the vessel 10 and the substantial enclosure 14 can be square, rectangular, circular, spherical, pie-shaped, etc. As another example, a vessel 10c can have a conformal shape, or a shape that conforms to, keys into, or matches another shape or structure, such as conforming to an allocated space in an airframe of fuselage of an aircraft. The term “substantial enclosure” is used herein to describe an enclosure shaped to hold or contain a material, such as liquid, and can be shaped as a bowl, tank, container, etc. The substantial enclosure 14 can include an opening 24 therein, and can be sealable, such as with a lid or cap. Thus, the substantial enclosure can be watertight. The material for the substantial enclosure can include plastic, thermoplastic, polyolefin, polyethylene, polypropylene, polyurethane, etc. The substantial enclosure 14 can form an inner layer of the vessel 10.

The bondable layer 22 can include a fibrous material with a plurality of fibers 26. Examples of the fibrous material include a fiber fabric, cloth, weave or mat. The fibers 26 can be configured in various different orientations. For example, the fibers 26 can be provided in a weave with fibers disposed in transverse orientations, weaving back and forth and overlapping other fibers. As another example, the fibers 26 can be provided in chopped strands. In addition, the bondable layer 22 or fibrous material can have a thickness formed by numerous overlapping fibers. The bondable layer 22 can have an inner side 30 and an outer side 34. The fibers 26 can extend between the inner and outer sides 30 and 34. The bondable layer 22 or fiber 26 can include graphite, fiberglass, etc.

The reinforcement layer 18 can include a fiber in a resin matrix, indicated together at 38. The fiber of the reinforcement layer 18 can include continuous fibers wrapped around the substantial enclosure 14. The fiber can be graphite, fiberglass, etc.

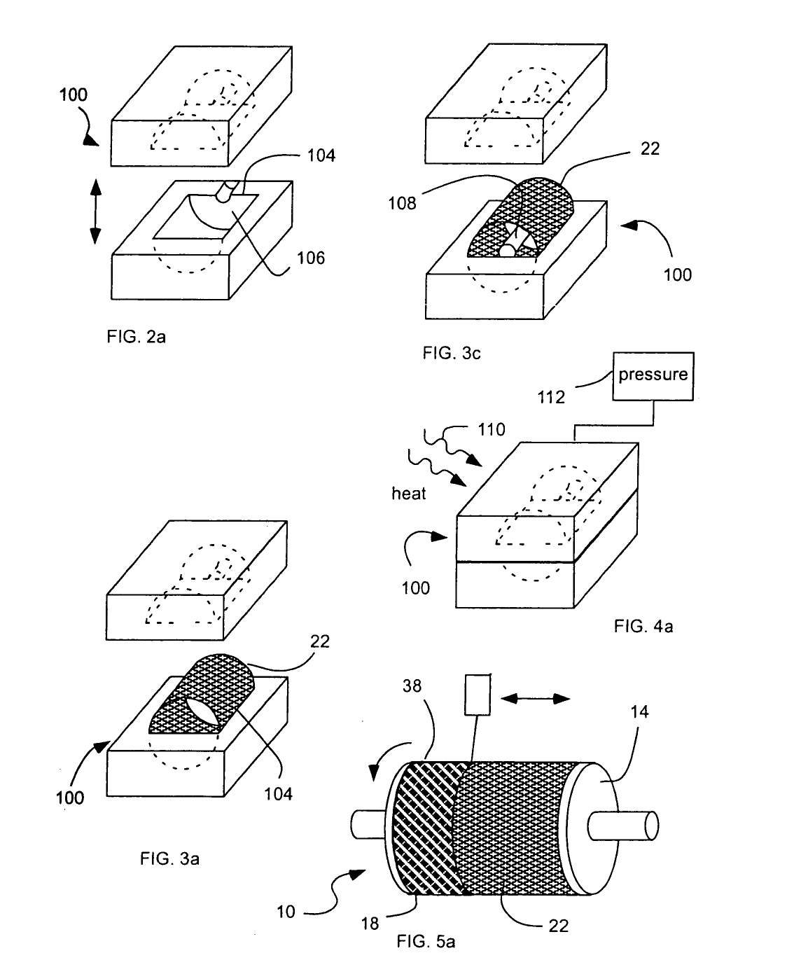

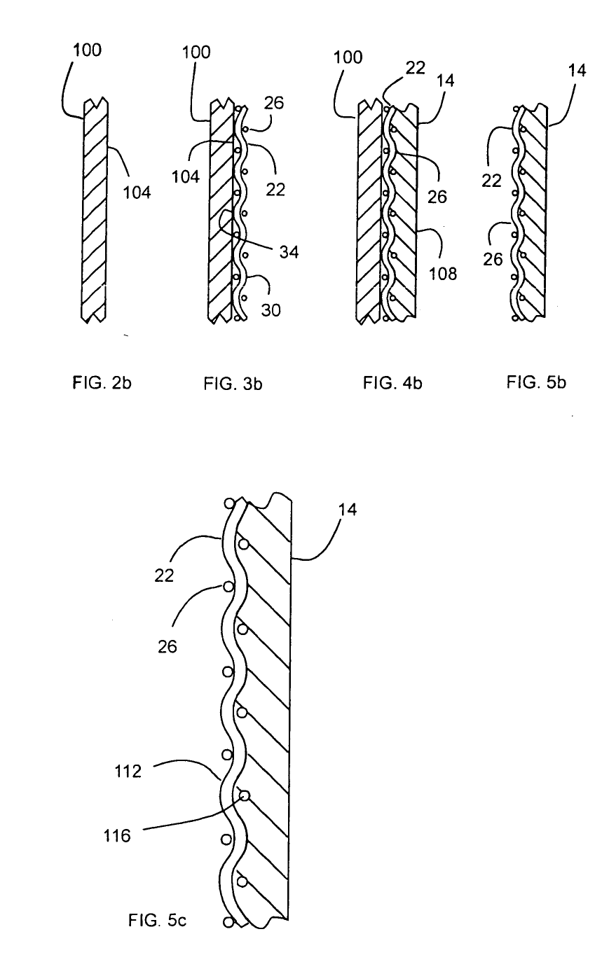

As illustrated in FIGS. 2a-5c, a method for forming a vessel in accordance with the present invention is shown. Referring to FIGS. 2a and 2b, a mold 100 with an inner surface 104 is shown for forming the substantial enclosure 14. A cavity 106 can be formed in the mold 104 that is shaped to form the enclosure 14. The mold 100 and the inner surface 104 can be shaped to form the substantial enclosure 14. The mold 100 can be provided in sections or halves that can be combined together to form the mold. The halves of the mold can be compressed together and held in place, as shown in FIG. 4a. The halves of the mold can be compressed by a hydraulic press or the like, as is known in the art.

Referring to FIGS. 3a and 3b, the bondable layer 22 is disposed on the inner surface 104 of the mold 100. The outer side 34 of the bondable layer 22 can be an attachment portion or side secured to the inner surface 104. The inner side 30 of the bondable layer 22 can be an exposed portion or side that faces into the mold. An example of a means for attaching or securing the bondable layer 22 to the inner surface 104 includes using an adhesive. The bondable layer 22 can be disposed around an entire periphery or circumference of the mold 100. For example, the bondable layer can be disposed in a cylindrical sleeve or jacket. Alternatively, the bondable layer can be disposed around an entire inner surface of the mold, so that the bondable layer surrounds the entire, or substantially the entire, enclosure 14. For example, the bondable layer can be disposed in a cylindrical shell with a top and bottom. Alternatively, the bondable layer can be disposed in separate and discrete patches at desired locations.

Referring to FIG. 3c, a preform 108 formed of a plastic material can be introduced into the mold 100. The preform 108 can be a hollow blank or tube with a fluid or air channel extending therethrough. Alternatively, the preform can have a different shape, and can be injection molded into various different shapes. The mold 100 can then be closed or sealed. Referring to FIGS. 4a and 4b, the mold 100 with the preform 108 therein can be heated, indicated at 110. The heat 110 can be applied by heating elements associated with the mold, as is known in the art. In addition, the preform 108 can be pressurized, such as by a pressure source 112. The simultaneous heat 110 and pressure cause the preform 108 to expand and compress against the inner surface 104 of the mold 100, and against the bondable layer 22. The plastic material adheres as a film to the interior surface of the mold, and/or the exposed portion 30 of the bondable layer 22. A plastic layer will result which forms the wall of the substantial enclosure. The plastic film or material will harden as the mold cools. The mold can be opened and the substantial enclosure removed. The molding process can form a substantial enclosure that is seamless and hollow, and with a substantially constant wall thickness.

Heating and pressurizing the mold 100 and the plastic material of the preform 108 causes the plastic material to conform to the mold 100, and to form the substantial enclosure 14. In addition, heating and pressurizing the plastic material 108 causes the plastic material to embed into the exposed portion 30 of the bondable layer 22 on the inner surface 104 of the mold 100. The plastic material permeates into a thickness of the bondable layer, and embeds into the fibrous material and around individual fibers or portions of individual fibers. The plastic material can substantially surround portions of the fiber, forming a mechanical attachment. For example, individual fibers can weave back and forth, into and out of the plastic material, indicated at 112 in FIG. 5c. As another example, entire fibers of a mat or weave can be embedded within the plastic material, indicated at 116 in FIG. 5c. The embedded plastic attaches the bondable layer 22 to the substantial enclosure 14. Thus, the bondable layer 22 or fibrous material is integrally molded into the substantial enclosure 14 or plastic material thereof. Furthermore, heating and rotating causes the plastic material to form an inner layer of the substantial enclosure 14 or vessel 10. The bondable layer 22 forms a layer around at least a portion of the inner layer.

While the exposed portion 30 of the bondable layer 22 is embedded into the plastic material of the substantial enclosure 14, the attachment portion 34 of the bondable layer becomes exposed when removed from the mold. The bondable layer 22, attached to the substantial enclosure 14 or inner layer, allows other items to be secured to the substantial enclosure 14 by attaching to the bondable layer, or attachment portion 34 thereof. Referring to FIG. 5a, the other items can include a reinforcement layer 18, such as a fiber in a resin matrix. Thus, the bondable layer 22 can form an intermediate layer between the other item or reinforcement layer 18, and the substantial enclosure 14 or inner layer. The reinforcement layer 18 can extend around a periphery or circumference of the substantial enclosure 14. For example, fiber can be continuously wound around the substantial enclosure 14 and the bondable layer 22. The fiber and resin can bond to the fibrous material of the bondable layer. Thus, the reinforcement layer 18 can bond to the bondable layer 22, while the bondable layer can be mechanically attached to the substantial enclosure 14 or inner layer. The fiber can be applied by continuous automatic winding, manual lay-up, fiber placement, automated tape, or other manual or automatic methods, and other types or configurations of fiber.

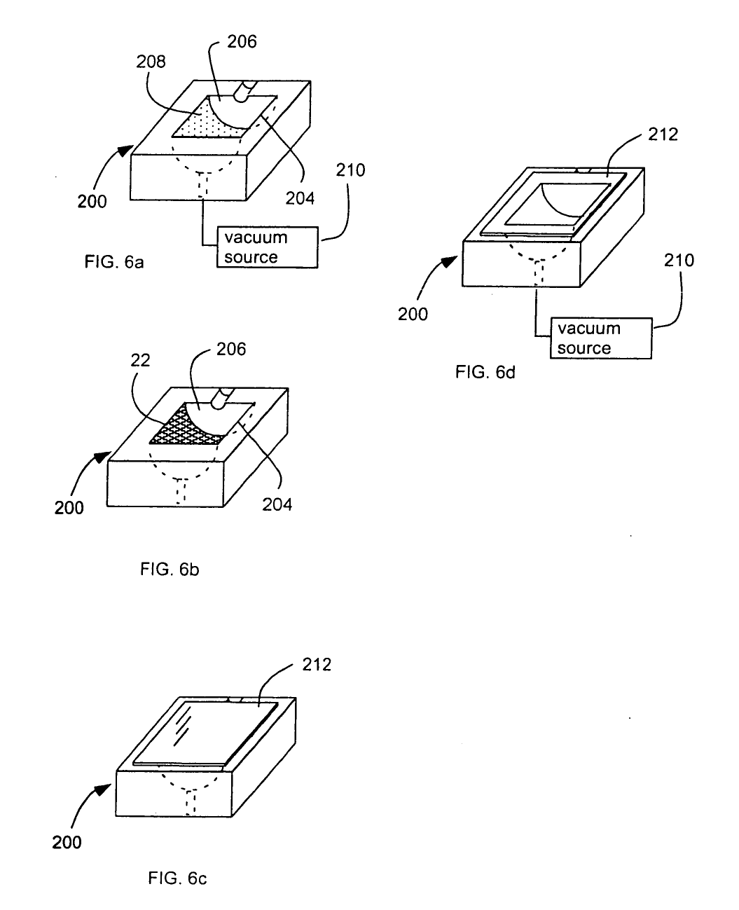

Other types of thermal forming can be used to form the vessels, including for example, vacuum forming or similar processes. Referring to FIG. 6a, a vacuum mold 200 with an inner surface 204 is shown for forming the substantial enclosure 14, or portion thereof. A cavity 206 can be formed in the mold 200 that is shaped to form the enclosure 14, or a portion thereof. The mold 200 and the inner surface 204 can be shaped to form the substantial enclosure 14, or a portion thereof The mold 200 can be provided in sections or halves of the substantial enclosure that can be combined together to form the substantial enclosure. A plurality of apertures 208 can be formed in the inner surface 204 of the mold and connected to a vacuum source 210, such as a pump. The vacuum source 210 can be used to create a pressure differential, discussed below.

Referring to FIG. 6b, the bondable layer 22 is disposed on the inner surface 204 of the mold 200, as described above. Referring to FIG. 6c, a sheet 212 formed of a plastic material can be disposed on or over the mold 200. The sheet 212 can be planer or flat, or can be a different shape. Referring to FIG. 6d, the mold 200 and/or sheet 212 can be heated. The heat can be applied by heating elements associated with the mold, as is known in the art. Alternatively, separate heaters can heat the sheet. In addition, the sheet 212 can be subject to a pressure differential, such as with the vacuum source 210. The heat and vacuum (ambient pressure) cause the sheet 212 to compress against the inner surface 204 of the mold 200, and against the bondable layer 22. The plastic material adheres to the interior surface of the mold, and/or the exposed portion 30 of the bondable layer 22. A plastic layer will result which forms the wall of the substantial enclosure, or a portion thereof. The sheet and/or mold can be cooled. The substantial enclosure 212 can be removed from the mold 200. The vacuum forming process can form a substantial enclosure, or portion of the substantial enclosure that can be combined with others to form the substantial enclosure. Heating and applying a vacuum to the plastic material of the sheet 212 causes the plastic material to conform to the mold 100, and to form the substantial enclosure 14, as described above. In addition, heating and applying a vacuum to the plastic material causes the plastic material to embed into the exposed portion 30 of the bondable layer 22 on the inner surface 204 of the mold 200. Other items can be secured to the substantial enclosure 14 by attaching to the bondable layer, or attachment portion 34 thereof, as described above.

Alternatively, the mold 200 can have a protrusion, as opposed to a cavity, with the plurality of apertures therein; and the sheet 212 can be formed against the protrusion.

Other types of molding or thermoforming can be used, including for example, resin transfer molding (RTM), twin sheet forming, etc.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

What is claimed is:

1. A method for forming a vessel, comprising the steps of:
a) adhering a bondable layer of fibrous material against an inner surface of a mold shaped to form a substantial enclosure;
b) disposing a preform formed of plastic material into the mold;
c) heating and pressurizing the preform causing the plastic material to expand and conform to the mold to form the substantial enclosure, and causing the plastic material to embed into an exposed portion of the fibrous material of the bondable layer;
d) removing the substantial enclosure with the bondable layer from the mold with a portion of the fibrous material of the bondable layer exposed; and
e) bonding a fiber with a resin matrix to the fibrous material of the bondable layer that is exposed while removed from the mold.

2. A method in accordance with claim 1, wherein the step of bonding the fiber in a resin matrix includes wrapping the fiber around the substantial enclosure.

3. A method for forming a vessel, comprising the steps of:
a) adhering a bondable layer of fibrous material against an inner surface of a mold shaped to form a substantial enclosure;
b) introducing a perform formed of plastic material into the mold and causing the plastic material to conform to the mold to form a substantial enclosure;
c) heating and pressurizing the preform to expand and embed into an exposed portion of the fibrous material of the bondable layer in the mold and attaching the bondable layer to the substantial enclosure; and
d) removing the substantial enclosure with the bondable layer from the mold.

4. A method in accordance with claim 3, further comprising the step of:
bonding another item to the bondable layer.

5. A method in accordance with claim 4, wherein the step of bonding another item to the bondable layer includes bonding a fiber with a resin matrix.

6. A method in accordance with claim 5, wherein the step of bonding the fiber in a resin matrix includes wrapping the fiber around the substantial enclosure.

7. A method for forming a vessel, comprising the steps of:
a) adhering a bondable layer of fibrous material against an inner surface of a mold shaped to form a substantial enclosure;
b) disposing a preform of plastic material in the mold;
c) heating and pressurizing the preform of plastic material causing the perform to expand and conform to the mold to form the substantial enclosure, and causing the plastic material to embed into an exposed portion of the fibrous material of the bondable layer;
d) removing the substantial enclosure with the bondable layer from the mold with a portion of the fibrous material of the bondable layer exposed; and
e) bonding a fiber with a resin matrix to the fibrous material of the bondable layer while removed from the mold.

8. A method in accordance with claim 7, wherein the step of bonding the fiber in a resin matrix includes wrapping the fiber around the substantial enclosure.

9. A method for forming a vessel, comprising the steps of:
a) disposing a bondable layer of fibrous material against an inner surface of a mold shaped to form a substantial enclosure;
b) disposing a perform of plastic material into the mold;
c) heating and pressurizing the preform causing the perform to expand and conform to the mold to form the substantial enclosure, and causing the plastic material to embed into an exposed portion of the fibrous material of the bondable layer;
d) removing the substantial enclosure with the bondable layer from the mold with a portion of the fibrous material of the bondable layer exposed; and
e) wrapping another fiber around the substantial vessel and applying a resin matrix to the another fiber and the fibrous material to bond the another fiber to the fibrous material of the bondable layer.
